(19) United States
(12) Patent Application Publication
(10) Pub. No.: US 2026/0127014 A1
(43) Pub. Date: May 7, 2026

(54) MANAGEMENT OF UNINTENTIONAL INPUT ON A COMPUTING DEVICE

(71) Applicant: Google LLC, Mountain View, CA (US)

(72) Inventor: Raymond Wensley Smith, London (GB)

(21) Appl. No.: 18/936,437

(22) Filed: Nov. 4, 2024

(51) Int. Cl. G06F 9/451; G06F 3/0482

(52) U.S. Cl. CPC G06F 9/453; G06F 3/0482

(57) ABSTRACT

According to at least one implementation, a method includes identifying a request for a summary of an action caused by an input received from a user, and identifying the action based on a proximity in time of the action to the request. The method further includes generating the summary, the summary including a descriptor for the action, and providing the summary as a response to the request.

### BACKGROUND

In modern computing devices, a user can frequently initiate actions that are unintended but still recognized by the device. These can include accidental keystrokes, touchpad or touchscreen presses or other gestures, mouse clicks, or voice commands that are mistakenly triggered. Unintentional inputs can occur due to user errors, such as accidentally brushing against a touch-sensitive surface or due to software or hardware glitches that misinterpret the user's actions.

### SUMMARY

This disclosure relates to systems and methods for providing users with options for responding to unintentional input. In at least one implementation, a computing device can be configured to monitor user inputs and corresponding actions from the inputs. User inputs may include touchpad or touchscreen presses, gestures, mouse clicks, voice commands, or other inputs. The actions can consist of retrieving and displaying data, generating notifications, performing calculations, updating records or settings, or other actions associated with an application or operating system of the device. In response to a user request for a summary associated with a recent input, the device can be configured to identify an action and at least one input that caused the action. The device can then be configured to give the user a descriptor of the action. The descriptor may include a pop-up visual indicator, an audio summary of the action, or another descriptor. In some examples, the device can further be configured to provide the user with a descriptor of the at least one action that caused the action. In some examples, the device can also be configured to provide options associated with the action, including maintaining the action, undoing the action, preventing the same input from causing the action in the future, or some other action. The user can use the descriptor information to select at least one option from the provided options.

In some aspects, the techniques described herein relate to a method including: identifying a request for a summary of an action caused by an input received from a user; identifying the action based on a recency of the action to the request; generating the summary, the summary including a descriptor for the action; and providing the summary as a response to the request.

In some aspects, the techniques described herein relate to a computer-readable storage medium having program instructions stored thereon that, when executed by at least one processor, direct the at least one processor to perform a method, the method including: identifying a request for a summary of an action caused by an input received from a user; identifying the action based on a proximity in time of the action to the request; generating the summary, the summary including a descriptor for the action; and providing the summary as a response to the request.

In some aspects, the techniques described herein relate to a computing apparatus including: computer-readable storage media; at least one processor operatively coupled to the computer-readable storage media; and program instructions stored on the computer-readable storage media that, when executed by the at least one processor, direct the computing apparatus to perform a method, the method including: identifying a request for a summary of an action caused by an input received from a user; identifying the action based on a proximity in time of the action to the request; generating the summary, the summary including a descriptor for the action; and providing the summary as a response to the request.

The accompanying drawings and the description below outline the details of one or more implementations. Other features will be apparent from the description, drawings, and claims.

### BRIEF DESCRIPTION OF THE DRAWINGS

FIG. 1 illustrates a computing environment to manage unintentional input on a computing device according to an implementation.

FIG. 2 illustrates a method of operating a computing device to manage unintentional input according to an implementation.

FIG. 3 illustrates an operational scenario of receiving a user request to identify descriptor information associated with unintentional input according to an implementation.

FIG. 4 illustrates an example data structure to associate user input to corresponding actions according to an implementation.

FIG. 5 illustrates an operational scenario of receiving a user request to identify descriptor information associated with unintentional input according to an implementation.

FIG. 6 illustrates an operational scenario of undoing an action based on a user preference according to an implementation.

FIG. 7 illustrates an operational scenario of updating user input preferences to limit an action based on user input according to an implementation.

FIG. 8 illustrates a computing system to manage unintentional input according to an implementation.

### DETAILED DESCRIPTION

Computing devices receive input through various interfaces and sensors. Examples of input devices include keyboards, mice, touchscreens, microphones, touch-sensitive wearables, wearables with inertial measurement units, and cameras, which convert physical actions like typing, clicking, speaking, or gestures into digital signals that the device can process. In some implementations, the device can be configured to generate a signal when a user interacts with the device (e.g., pressing a key, clicking a mouse, making a gesture, or touching a screen). This signal is processed by the operating system or application, which interprets it as input data (e.g., a specific key press or a click). The data is then processed according to the programmed logic associated with the operating system or application. The operating system or application responds to the input by executing an action, such as displaying text, opening a menu, performing a calculation, changing a setting, or some other action, depending on the input context.

However, unintentional inputs can occur due to user errors, such as brushing against a touch-sensitive surface or pressing a key on a keyboard. As at least one technical problem, these inputs can lead to unintended commands being executed, which may disrupt the user's workflow or cause errors on the device.

In at least one technical solution, a device can be configured to monitor user inputs and identify the inputs to actions caused by the inputs. For example, with user permission, the device can maintain a log that indicates one or more inputs (e.g., keyboard inputs, touch inputs, and the like) and the associated action that occurred because of the inputs (e.g., adding an object to the display, playing a sound, opening a menu, and the like). When the user generates a request for a summary of a recent action, such as the last action implemented from user input, the device can be configured to identify the recent action and generate a descriptor of the most recent action. The descriptor for an action is a term or phrase that characterizes the specific nature, attributes, or details of the action, helping to convey what was performed by the action. In some implementations, the device can be configured with a natural language generator to form one or more sentences describing the action. A natural language generator includes software that produces human-like text based on data inputs using algorithms and models (e.g., neural networks). It can create coherent sentences and paragraphs, allowing the system to summarize the action for the requesting user. For example, when a user input initiates the display of a new menu in an application, the descriptor can indicate the menu's name, the information included in the menu, or some other information associated with the menu. The data for the summary can be extracted from the display, from information provided by the application, or by some other means.

In some technical solutions, in addition to providing information about the action, the device can further be configured to generate a descriptor of one or more user inputs that caused the display of the menu. For example, a touch input can cause the display of a new menu. When the user requests a summary of the recent action, the device can be configured to provide a descriptor that indicates the option selected by the touch, the location of the touch on the display, or some other information associated with the input. In some implementations, the input descriptor includes a text-based summary, the text-based summary generated using a natural language generator in some examples. In some examples, the input descriptor can consist of visual highlights, shading, or some other operation to highlight a portion of the display or application that caused the action. Returning to the example of the menu, if the input includes the user selecting an option, such as a button, in an application (either through touch, a mouse, or some other input operation), the device can be configured to highlight the button on the display to illustrate the location of the button. As at least one technical effect, the user can identify the one or more inputs that caused the action on the device.

In some technical solutions, the device can be configured to provide options associated with the action. The options can include maintaining the action, undoing the action, preventing the same input from causing the same action, or some other options. For example, when the user input causes the display of a new menu, the device can be configured to display a list of options associated with the menu. From the list of options, the user can select an option to prevent the display of the menu in response to the same input. Consequently, when the user provides the same input (e.g., a touch to the same location), the device can be configured to prevent the display of the menu. As a technical effect, the user can define how the input is handled in the future, providing flexibility to prevent undesired actions.

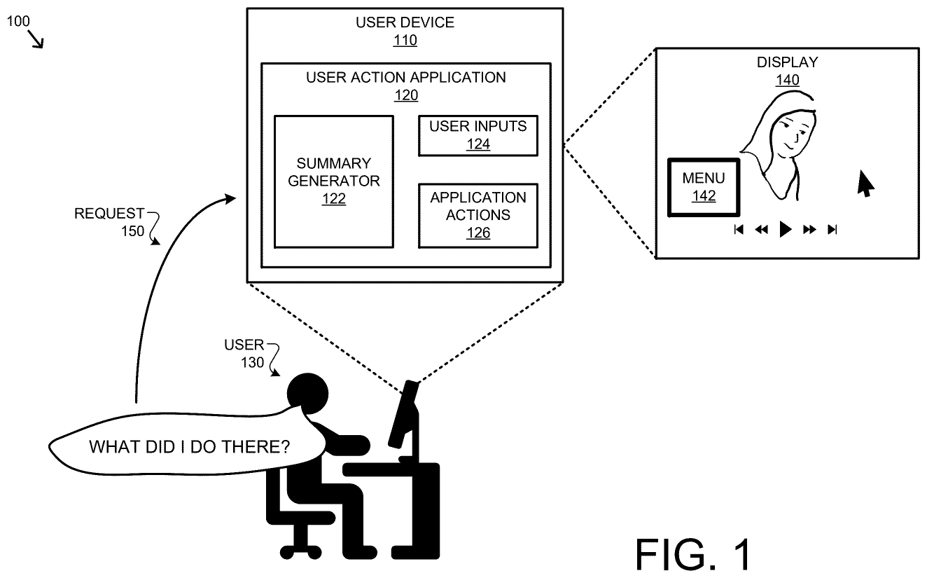

FIG. 1 illustrates a computing environment 100 to manage unintentional input on a computing device according to an implementation. Computing environment 100 includes user device 110, user 130, request 150, and display 140, which is representative of the display provided by user device 110. User device 110 provides user action application 120, which includes a summary generator 122, user inputs 124, and application actions 126. Display 140 further includes menu 142.

User device 110 can represent a desktop computer, laptop computer, smartphone, tablet, or other computing device. User device 110 can be configured to monitor user input and associate the input to actions related to an application or operating system of user device 110. For example, in a word processing application, the user can provide a keystroke associated with a letter, and the action will display the letter on the document for the user. User action application 120 can maintain a log consisting of user inputs 124 and application actions 126. User inputs 124 and application actions 126 can include inputs and corresponding actions for a recent time frame (e.g., ten minutes), a recent quantity of actions (e.g., ten most recent actions), or for some other period.

While user action application 120 maintains the user inputs 124 and application actions 126, user action application 120 can be configured to identify request 150 from user 130. Request 150 is used by user 130 to determine a recent action taken by user device 110. For example, the user may provide one or more inputs that cause menu 142 to appear on display 140. When user 130 views menu 142, the user may generate request 150 to determine the one or more inputs that caused the display of menu 142. In response to the request, user action application 120 will use user inputs 124 and application actions 126 to determine a recent action on the device and generate a summary using summary generator 122. The summary can include a descriptor associated with the action, a descriptor of the one or more inputs (or set of inputs) that caused the action, options for handling the current input, options to handle future inputs, or some other summary information for the user 130. Referring to the example of menu 142, when user 130 generates request 150, user action application 120 can be configured to generate a summary that indicates a summary of what action was caused (i.e., menu 142 displayed, what menu 142 is used for, and the like), the one or more user inputs that caused the display of menu 142 (e.g., unintentional touch to user device 110, and options for handling the one or more user inputs that caused the display of the menu.

Summary generator 122 can comprise a natural language model (NLM) in some implementations. An NLM can generate a summary by first understanding the information in the input text. The information can include titles associated with the action (e.g., name of menu 142), metadata associated with the action, information provided by the software associated with menu 142, or some other information. The NLM can analyze the content of the information, identifying the main points, important details, and overall context. The model can use techniques like tokenization to break down the text into manageable parts, assign importance to sentences or phrases, and then rephrase or condense the information while maintaining coherence and meaning. In some implementations, the summary can be provided via a visual display on display 140. In some implementations, the summary can be provided via a speaker that generates an audible summary for user 130.

In some examples, when the summary includes options for the user, user device 110 can be configured to identify a selection from the user and initiate an action based on the selection. For example, the user can be provided with options to keep the action, to undo the action, and to prevent future actions from similar input (e.g., a touch to a portion of display 140). In response to the user providing input to undo the action of displaying menu 142, user action application 120 can undo the display of menu 142.

Further to the descriptions above, a user may be provided with controls allowing the user to make an election as to both if and when systems, programs, or features described herein may enable collection of user information (e.g., information about a user's inputs, user's actions, a user's preferences, a user's current location, etc.), if and when user content is provided to a server, and if the user is sent content or communications from a server. In addition, certain data may be treated in one or more ways before it is stored or used so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user. In some implementations, the user can have control over what inputs are logged, what actions are logged in association with the inputs, what applications are monitored, or some other control over the unintentional input log.

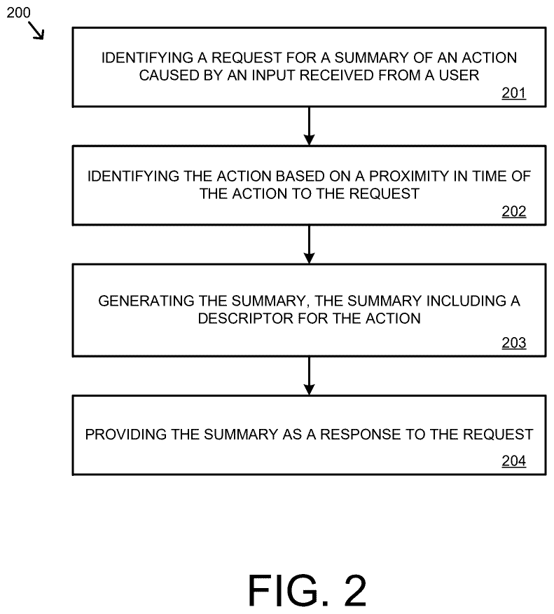

FIG. 2 illustrates method 200 of operating a computing device to manage unintentional input according to an implementation. Method 200 can be performed by user device 110, wherein user device 110 can comprise a laptop computer, smartphone, tablet, or some other device.

Method 200 includes identifying a request for a summary of an action caused by an input received from a user at step 201. In response to the request, method 200 further includes identifying the action based on a proximity in time (or a recency) of the action to the request at step 202. In some implementations, in identifying the proximity in time, the device can be configured to identify the most recent action caused by user input. The action can include accessing hardware (e.g., camera, device location, and the like), managing files, sending notifications, displaying visual elements, collecting data, communicating with other applications or networks, or some other action. For example, in computing environment 100, an action may include displaying a new menu or some other visual element.

Method 200 further includes generating the summary, the summary including a descriptor for the action at step 203 and providing the summary as a response to the request at step 204. In some implementations, generating the summary can include generating a natural language summary based on information about the action. The information for the action can be provided by the application or operating system operating on the device. The information can include a name for an object displayed, executables implemented as part of the action, metadata associated with the action (e.g., descriptions of the action), one or more touch inputs that caused the action, or some other information. In some implementations, the summary can be generated using an NLM. An NLM generates the summary by analyzing the information about the action (e.g., text descriptors), identifying key points and features of the action, and then rewriting the information concisely and coherently while preserving the crucial details of the action. The model can be configured to use tokenization, understanding context, and prioritizing information based on relevance and significance. For example, suppose the user input causes a menu to be displayed. In that case, a natural language summary can provide the name of the menu, the application associated with the menu, the use case for the menu, or some other information related to the menu.

In some implementations, besides including the descriptor for the action, the summary can provide a descriptor about the one or more inputs (i.e., set of inputs) that caused the action. The descriptor can include a list of the inputs, a natural language summary of the inputs, a visual depiction of the image (e.g., the location of an unintentional touch), or some other descriptor associated with the touch. In some examples, the device can be configured to use an NLM that identifies information about the touch inputs (location, objects touched, metadata, or other information associated with the input). In some implementations, the NLM generates text by first converting input text into numerical vectors through tokenization and embedding. It then processes these vectors through multiple neural network layers, using mechanisms like self-attention to understand context and relationships within the text. Finally, the model predicts the next words or sentences based on this contextual understanding, generating coherent and contextually relevant output. Here, the output can include a text summary indicating the one or more inputs that caused the action (location of the one or more inputs, types of inputs, etc.).

In some implementations, the summary can include options for handling the one or more inputs that caused the action. The options can include maintaining the action, undoing the action, preventing the action when the same inputs occur, or some other option. For example, the device can present options as selectable buttons for the user. When the user selects the option to undo the action, the device can update preferences or settings to prevent the inputs from causing the action.

In some implementations, the initial summary provided by the device may not provide the desired information for the user. For example, when the user provides quick input to the device, the device can initiate a sequence of actions in response to the quick inputs. In response to the user requesting a summary of a recent action, the device can provide a first summary to the user (e.g., the summary for the most recent action). The device can then provide an option for another action (e.g., the action occurring before the most recent action). In response to the user selecting the option, the device can provide a second summary for the other action. The process can be repeated until the user receives the desired summary corresponding to an action on the device. In some examples, the device may maintain a log indicating the order of actions and corresponding inputs that caused the actions. The log can be traversed to identify the action associated with the user request.

In some implementations, in selecting the action for the summary, the device can consider other factors, such as workflow conditions, locations of different inputs on the device, or some other factor to identify the context associated with the request. For example, when most of the inputs for the user are in a first location on a device's touch display, a recent input that exceeds a threshold distance from the other inputs can be identified as a potential unintended input. That input can then be selected for the user's summary. As another example, the device can monitor the user's workflow and identify an input unrelated to one or more other inputs on the device. The input can then be selected for the summary provided to the user. Various conditions and criteria can be used to select the input most likely referenced by the user, including the time relationship to the user requesting the summary, the workflow conditions associated with the input, the input locations on the display, or some other condition.

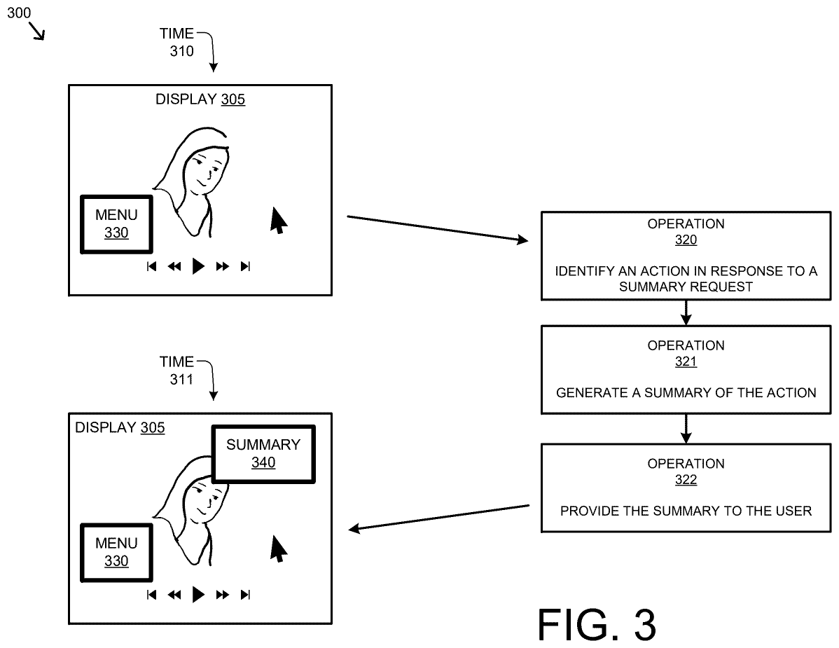

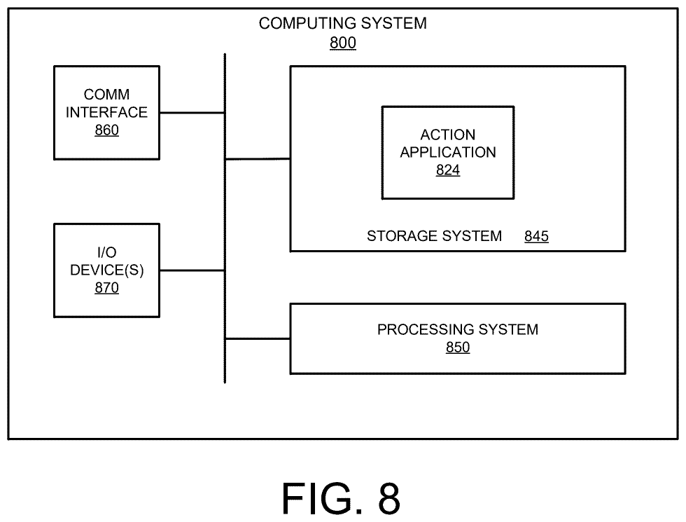

FIG. 3 illustrates an operational scenario 300 of receiving a request to identify descriptor information associated with unintentional input according to an implementation. Operational scenario 300 includes display 305 at times 310-311 and operations 320-322. Display 305 includes menu 330 at time 310 and menu 330 and summary 340 at time 311. Any user computing device, such as a smartphone, tablet, laptop, or desktop, can implement operations 310-311. An example device is provided as computing system 800 in FIG. 8.

In operational scenario 300, a user provides input that causes the display of menu 330 on display 305 at time 310. After the display of menu 330, operation 320 identifies a summary request and an action in response to the summary request. In some implementations, the request comprises a vocal request for a summary associated with a recent action on the computing device. In some implementations, the request includes user input using a physical or digital button requesting a summary associated with a recent action. Here, in response to the request, the device identifies the display of menu 330 as the action caused by one or more user inputs. In some examples, the device selects the most recent action in time proximity to the request for the summary. In some examples, the device selects the action based on one or more additional criteria. The additional criteria can include workflow objectives identified for the user (e.g., identifying similarities with other inputs), locations of inputs from the user (e.g., identifying variances between input locations on the display), or some other criteria. For example, while a first action may not be the most recent to the request, the device can identify the first action for the summary based on the variance of one or more inputs for the first action relative to other inputs from the user (and the associated actions). The variance can include the first action being unrelated to the workflow of other actions from the user, the location of the first action being in a different location on the display from the other actions of the user, or some other variance associated with the inputs or actions.

Once the action is identified, operation 321 generates a summary of the action. The summary can comprise a text-based summary, an image-based summary, a demonstration-based summary (e.g., highlighting elements on the display), an audio summary, or some other summary, including combinations thereof. Once the summary is generated, operation 322 provides the summary to the user. In the example of time 311 on display 305, the device offers summary 340 as a window overlaid on display 305. The summary can include text or images that give a descriptor associated with the action of displaying menu 330.

In some implementations, the summary is derived from information displayed as part of menu 330, metadata associated with menu 330, the location of menu 330 on display 305, or some other information. In some implementations, the application associated with menu 330 provides summary 340. In other implementations, an operating system or second application on the device interacts with the application for menu 330 to obtain the required information. In at least one example, the operating system interacts with the application for menu 330 using an application programming interface (API). An API is a set of rules and protocols that allows different software applications to communicate with each other. It defines the methods and data formats applications can use to request and exchange information, enabling integration and functionality sharing between the operating system and the application. In some examples, the exchange permits the operating system to maintain information about actions for various applications executing on the device. The actions can include displaying content, sending a notification or message, generating a selection of an object in the application, updating a setting for the device, or some other action. A summary can be generated for the user based on the information.

In some implementations, the device uses an NLP to generate natural language from the information associated with the action. Natural Language Generation (NLG) converts structured information into human-readable text by selecting and organizing relevant content and then deciding on sentence structure and word choice. Finally, it generates coherent and grammatically correct sentences to convey the intended message. In some implementations, in addition to or in place of the natural language generation, the device can highlight, change color, increase the size, or provide some other action to draw attention to displayed objects associated with the action. For example, at time 311, menu 330 can be outlined or highlighted to indicate the menu described by summary 340.

Although demonstrated in the example of operational scenario 300 as providing a summary associated with a single action, the device can summarize multiple recently implemented actions. The user can identify the action corresponding to the unintentional input from the list. For example, the device can be configured to provide the user with the five most recent actions, each caused by a set of one or more inputs. The user can use the summary provided for each action to determine which actions were associated with the unintentional input (or inputs).

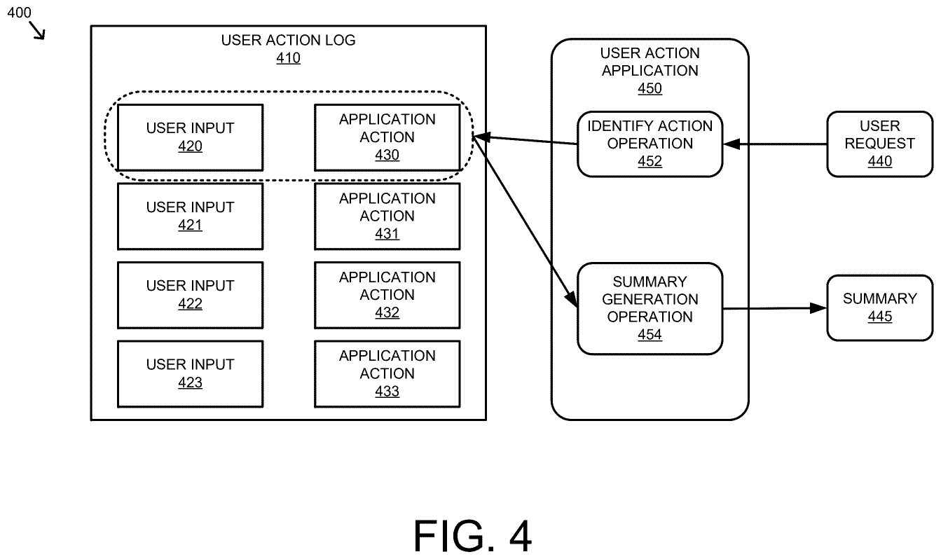

FIG. 4 illustrates an operational scenario 400 to map user input to corresponding actions according to an implementation. Operational scenario 400 includes user action log 410, user action application 450, user request 440, and summary 445. User action application 450 includes identify action operation 452 and summary generation operation 454. User action log 410 includes user inputs 420-423 corresponding to application actions 430-433. Application actions 430-433 may correspond to a single application or multiple applications in some examples. User action application 450 represents an application that a user device, such as a smartphone, tablet, laptop, desktop computer, or some other computing device, can execute. An example of the user device is demonstrated in FIG. 8 as computing system 800. Although shown as a single input per application action in operational scenario 400, the device can store a set of one or more inputs associated with an individual action. For example, a user can use a combination of keys on a keyboard to trigger an action on the device. User action log 410 can maintain the combination as the set of user inputs that caused the corresponding action.

In operational scenario 400, identify action operation 452 identifies user request 440. User request 440 may represent a user's touch to a physical button, a user's request to a button presented on a display, a voice command, or some other request. In response to the request, identify action operation 452 can determine an action and corresponding input based at least on a proximity in time of the action to the request. Proximity in time refers to how close or near two events are to each other regarding when they occur. Specifically, how near the input occurs in relation to the summary request. In some examples, the device can identify the most recent input and action pair to the summary request. As demonstrated in user action log 410, user inputs 420-423, and application actions 430-433 are represented based on their occurrence relative to user request 440. The input and action pairs can be identified from the operating system, from the applications on the device using an API in some examples, or by some other means for identifying the input and action pairs implemented on the device. Here, identify action operation 452, which identifies user input 420 and application action 430, based on application action 430 being the nearest in proximity to user request 440.

In some implementations, identify action operation 452 can consider additional factors or criteria to determine the action associated with the request. In some examples, an additional factor can include identifying workflow operations from the identified actions and identifying an action as an outlier from the workflow operations. A user's workflow in an application involves accessing the app, performing tasks through the interface, and completing actions to achieve their goals. An action that is outside the process of completing the goals could be identified as an outlier, such as an action that is not typically implemented in proximity to one or more other actions initiated from user input. In some examples, an additional factor can include identifying input locations outside of a threshold region associated with other input locations. For example, a user can provide five inputs within a top left quarter of the display, but a sixth input is provided in the lower right quarter of the display. The device can determine that the touch was unintentional because the input is provided in a different portion of the screen or is a threshold distance away from the other inputs. The device can then determine a summary for unintentional input, wherein the summary can include text, images, highlights, and the like that provide a descriptor for the action and/or the input that caused the action.

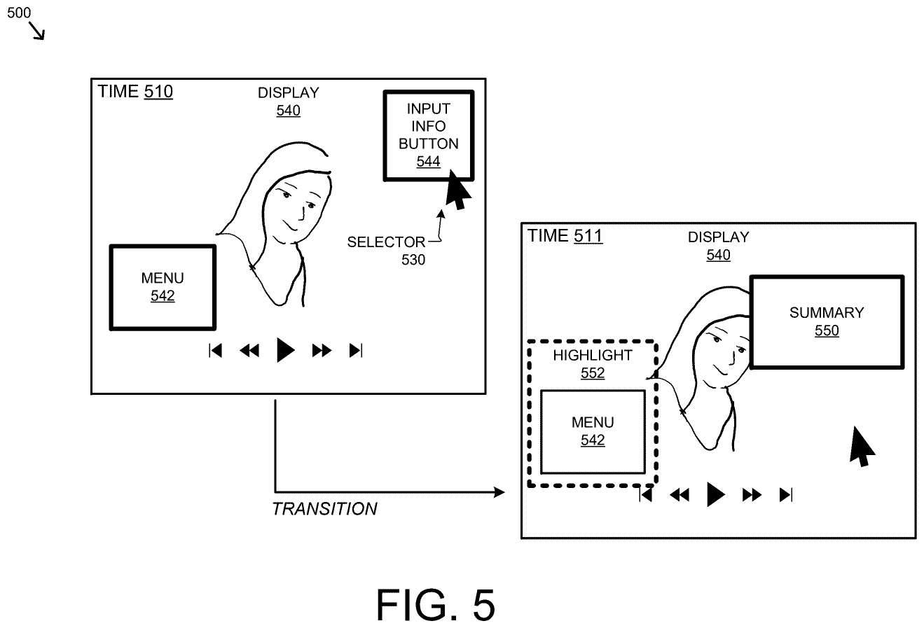

FIG. 5 illustrates an operational scenario 500 of receiving a user request to identify descriptor information associated with unintentional input according to an implementation. Operational scenario 500 includes display 540 at time 510 and time 511. Operational scenario 500 further includes selector 530, menu 542, input information (info) button 544, summary 550, and highlight 552. Operational scenario 500 can be implemented by a user device, such as a smartphone, tablet, laptop, desktop computer, or some other computing device. An example of the user device is demonstrated in FIG. 8 as computing system 800.

In operational scenario 500 at time 510, a user uses selector 530 to select input information button 544 on display 540. Input information button 544 summarizes an action the user device takes in response to a user input. Inputs to a user device can include touch (via touchscreen), keyboard input, mouse clicks, voice commands, gestures, stylus input, and sensor data (such as accelerometer or GPS). For example, the user can use selector 530 to select input information button 544 in response to providing an unintentional touch that causes the display of menu 542. In response to selecting input information button 544, the user device can determine an action associated with the request based at least on a proximity in time of the action to the request. In some implementations, the device can identify the action that was taken most recent to the request from the user. For example, if the display of menu 542 was the most recent action by an application on the device, then the display of menu 542 will be identified as the action. In some implementations, the device can consider other factors in selecting the action associated with the request. The other factors can include the workflow of the user (e.g., other actions near in time proximity), the location of the inputs on the device, or some other factor. The workflow can be used to determine an action that deviates from the workflow of other actions in the same period. The location of the inputs can identify an input that deviates from the input locations of other inputs in a period. Accordingly, in some technical solutions, rather than providing the most recent action, the device can provide a summary associated with the action that deviates from the workflow or input locations on the device.

Turning to time 511, in response the selection of input information button 544, the user device transitions display 540 to provide highlight 552 of menu 542 and summary 550. Highlight 552 can use colors or shaders to emphasize the menu or object that was created from the unintentional user action (in this example menu 542). Although demonstrated as a highlight, other attention mechanisms can be employed by the user device including borders, shading, blinking, enlarging, changing color, applying a shadow, or animating the object to draw attention without direct highlighting.

In addition to highlight 552 associated with menu 542 and the unintentional user action, summary 550 is provided. Summary 550 can comprise a text summary in some examples. A text summary of the action generated by the user device is a brief, concise description of a task or event that the device has performed or will perform. It typically includes key details such as the type of action, the subject or object involved, and the outcome or intended result. In some examples, the user device generates summary 550 by leveraging NLP algorithms that analyze the input data or event details, identify key elements, and automatically generate a coherent and concise description. These algorithms interpret the context of the action (e.g., device activity, system updates, display updates, notifications, etc.), determine important information like the purpose, status, or results, and output a human-readable summary. The information can be derived from the contents on the display, metadata associated with the action, or some other means associated with the executed action.

Although demonstrated with summary 550 and highlight 552, the summary for an action can take various forms, including images, text, highlights, videos, or some other summary to indicate the action and the one or more inputs that caused the action. In some implementations, the initial summary generated by the device may not correspond to the user's unintentional input. The device can be configured to allow the user to request a second action. The user device can select the second action based on the proximity in time to the request, the relation to the workflow of other actions, the proximity of the input to other inputs within a period, or some other factor, including combinations thereof.

Although demonstrated as an onscreen button to obtain the summary, the user can request a summary using alternative operations. In one implementation, the user can request the summary for the action using a voice command. In one implementation, the user can request the summary using a physical button on the device. In other implementations, the user can use a gesture or some other input mechanism to obtain the summary.

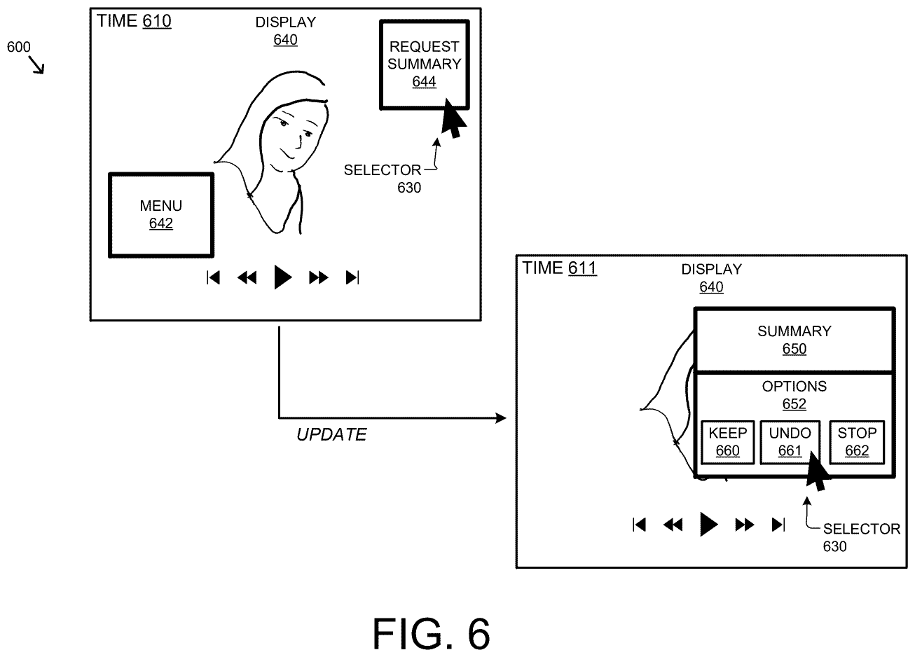

FIG. 6 illustrates an operational scenario 600 of undoing an action based on a user preference according to an implementation. Operational scenario 600 includes display 640 at time 610 and time 611. Operational scenario 600 further includes selector 630, menu 642, request summary 644, summary 650, options 652, and buttons to keep 660, undo 661, and stop 662. Operational scenario 600 can be implemented by a user device, such as a smartphone, tablet, laptop, desktop computer, or some other computing device. An example of the user device is demonstrated in FIG. 8 as computing system 800.

At time 610 in operational scenario 600, a user of the device uses selector 630 to select request summary 644. Request summary 644 is used to generate a summary related to an action caused by input from the user. Although demonstrated as visual button on display 640, the user can request the summary using a gesture, voice input, a physical button, or by some other input mechanism. In operational scenario 600 the action corresponds to the display of menu 642.

In response to providing the request for the summary, at time 611, display 640 is updated to include summary 650, options 652, and buttons to keep 660, undo 661, and stop 662. Summary 650 can comprise text, images, video, or some other information to summarize an action caused by user input. In some implementations, to generate a text summary, the device can be configured to extract the structured data from menu 642, such as items, categories, and descriptions, using Optical Character Recognition (OCR) or accessing an underlying data source like metadata for the menu, an API, or database if available. Next, the device can apply NLP techniques to identify elements, such as popular items, categories, or unique features, while removing unnecessary details. Using summarization algorithms, the system then condenses the information into a brief, coherent description, focusing on the most relevant aspects. The text summary can indicate a summary of the action and can further indicate the inputs that caused the action. In some examples, the summary can include images, highlighting, videos, or some other information to summarize the action or the inputs causing the action.

In addition to summary 650, options 652 are provided including keep 660, undo 661, and stop 662. Keep 660 is used to maintain the appearance of menu 642 from the user input, undo is used to remove or undo the appearance of menu 642, and stop 662 prevents the same user input from displaying menu 642 in the future.

In the example of operational scenario 600, the user uses selector 630 to select undo 661. In response to the selection of undo 661, menu 642 is removed from display 640. The user can further select other options, such as stop 662, that would further prevent future actions from occurring when the same input is provided. In some implementations, after selection of an option from options 652, the menu, including summary 650 and options 652 can be removed from display 640.

In some implementations, the computing device can monitor and identify a user input that is frequently associated with unintentional actions. For example, on a touch device, the user can often provide an input that causes one or more different unintentional actions (e.g., an accidental swipe when picking up the device that causes the unintentional actions). One or more unintentional actions can correspond to various applications but occur due to similar conditions and inputs from the user. For example, if the touch device user frequently provides a swipe input when picking up the touch device, causing one or more unintentional actions, the computing device can prevent other actions associated with the swipe input from being performed. The computing device can consider various factors when determining whether the touch input is like the unintentional touch input, including the gaze of the user relative to the device (i.e., looking at or looking away from the device), the orientation of the device during the input (i.e., facing down), or some other factor. For example, the user can provide unintentional input when moving the device from a first orientation (e.g., facing down) to a second orientation (e.g., facing up). In response to the unintentional input, the device can identify one or more actions rejected or undone by the user using the abovementioned operations (e.g., a menu undoing the operations). The device can identify similarities between the inputs (including orientation of the device, user position relative to the device, etc.), and can be configured to reject or prevent similar inputs from causing other operations that have not been explicitly undone or rejected by the user. Thus, if the user rejects two similar inputs in a first set of applications, the device can be configured to block a third input in a second set of applications without the user explicitly preventing the action.

In some implementations, the device is configured to identify a new input from the user and determine whether the new input satisfies at least one criterion indicating a similarity to another input whose associated action has been undone or blocked from being implemented. The at least one criterion can include the gesture associated with the input, the location of the input, the orientation of the device, the movement of the device, or some other criterion. If the new input satisfies the at least one criterion relating to the blocked or undone action, then the second action associated with the new input can also be blocked by the device. In some implementations, the device can compare the new input to multiple inputs whose associated actions have been blocked or undone. Based on the new input satisfying similarity criteria to the other inputs, the device can be configured to block the action associated with the new input. Otherwise, when the requirements are not satisfied, the device can be configured to permit the action related to the new input.

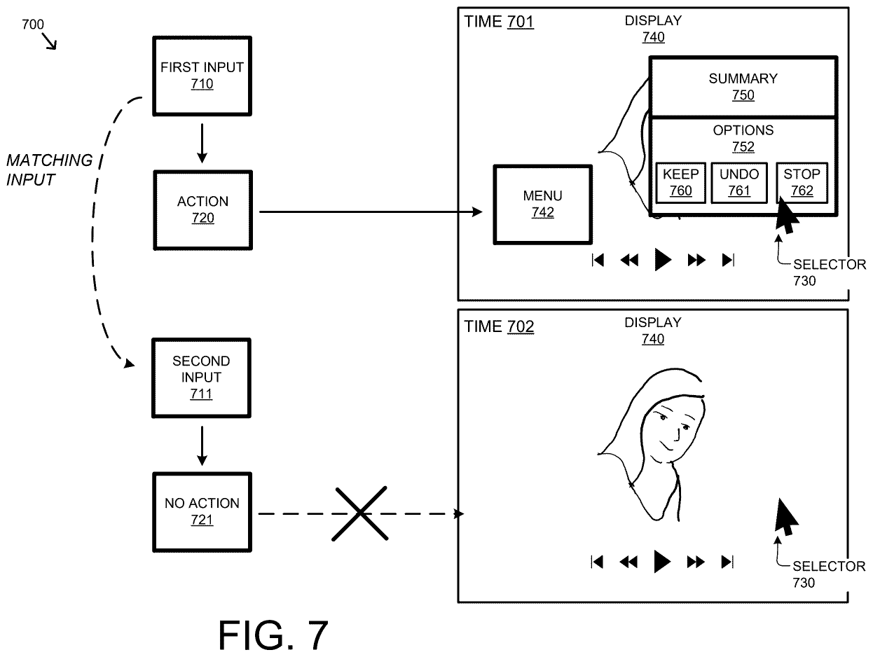

FIG. 7 illustrates an operational scenario 700 of updating user input preferences to limit an action based on user input according to an implementation. Operational scenario 700 includes display 740 at time 701 and time 702. Operational scenario 700 further includes first input 710, action 720, second input 711, and no action 721. Display 740 at time 701 includes selector 730, menu 742, summary 750, and options 752 with options to keep 760, undo 761, and stop 762. Display 740 at time 702 includes selector 730.

In operational scenario 700 and at time 701, a user provides first input 710 that causes action 720. Input 710 can include a touch input, a voice input, a keyboard stroke, or some other input to a computing device. In response to first input 710, the computing device provides action 720 that generates menu 742. Once menu 742 is displayed, the user requests a summary of action 720, which produces summary 750 and options 752 with options to keep 760, undo 761, and stop 762.

Summary 750 can comprise text, images, video, or some other information to summarize an action caused by user input. In some implementations, to generate a text summary, the device can be configured to extract the structured data from menu 742, such as items, categories, and descriptions, using Optical Character Recognition (OCR) or accessing an underlying data source like metadata for the menu, an API, or database if available. Next, the device can apply NLP techniques to identify elements, such as popular items, categories, or unique features, while removing unnecessary details. Using summarization algorithms, the system then condenses the information into a brief, coherent description, focusing on the most relevant aspects. The text summary can indicate a summary of the action and can further indicate the inputs that caused the action. In some examples, the summary can include images, highlighting, videos, or some other information to summarize the action or the inputs causing the action.

In addition to summary 750, options 752 are provided including keep 760, undo 761, and stop 762. Keep 760 is used to maintain the appearance of menu 742 from the user input, undo is used to remove or undo the appearance of menu 742 and stop 762 prevents the same user input from displaying menu 742 in the future. In the example of time 701, the user selects stop 762 to stop future actions an input that generates menu 742.

At time 702, the user provides second input 711 that provides no action 721 based on the user preference to not generate menu 742. In some implementations, the computing device can maintain a data structure or file that indicates preferences associated with different inputs (i.e., applications, inputs, and the like). When the user provides second input 711, the computing device performs a check of the saved preferences and determines that no action should be taken.

In some implementations, the device can maintain information about inputs and other factors associated with unintentional actions. The other factors can include the device's orientation, the user's location relative to the device, or other factors. The inputs and other factors associated with undesirable actions can be used by the device to prevent unintentional actions by the device without a manual configuration. For example, a user may provide input or feedback that prevents future actions associated with a first input and a second input associated with a first application and a second application. Based on the similarity of a third input to the first input and the second input, the device can be configured to prevent the action associated with the third input. The action can be blocked based on the input and the aforementioned factors. In some implementations, the third input can be associated with a different application than the first input and the second input. Accordingly, when the third input is associated with an unrelated application, the device can prevent an action when the input provides similar characteristics to the first input and the second input.

FIG. 8 illustrates a computing system 800 to manage unintentional input according to an implementation. Computing system 800 represents any computing system or systems with which the various operational architectures, processes, scenarios, and sequences disclosed herein for dynamically displaying a cursor may be implemented. Computing system 800 is an example of an XR device or some other computing device capable of the operations described herein. Computing system 800 includes storage system 845, processing system 850, communication interface 860, and input/output (I/O) device(s) 870. Processing system 850 is operatively linked to communication interface 860, I/O device(s) 870, and storage system 845. In some implementations, communication interface 860 and/or I/O device(s) 870 may be communicatively linked to storage system 845. Computing system 800 may further include other components, such as a battery and enclosure, that are not shown for clarity.

Communication interface 860 comprises components that communicate over communication links, such as network cards, ports, radio frequency, processing circuitry (and corresponding software), or some other communication devices. Communication interface 860 may be configured to communicate over metallic, wireless, or optical links. Communication interface 860 may be configured to use Time Division Multiplex (TDM), Internet Protocol (IP), Ethernet, optical networking, wireless protocols, communication signaling, or some other communication format—including combinations thereof. Communication interface 860 may be configured to communicate with external devices, such as servers, user devices, or some other computing device.

I/O device(s) 870 may include peripherals of a computer that facilitate the interaction between the user and computing system 800. Examples of I/O device(s) 870 may include keyboards, mice, trackpads, monitors, displays, printers, cameras, microphones, external storage devices, sensors, and the like.

Processing system 850 comprises microprocessor circuitry (e.g., at least one processor) and other circuitry that retrieves and executes operating software (i.e., program instructions) from storage system 845. Storage system 845 may include volatile and nonvolatile, removable, and non-removable media implemented in any method or technology for storage of information, such as computer-readable instructions, data structures, program modules, or other data. Storage system 845 may be implemented as a single storage device but may also be implemented across multiple storage devices or sub-systems. Storage system 845 may comprise additional elements, such as a controller to read operating software from the storage systems.

Examples of storage media (also referred to as computer-readable storage media) include random access memory, read-only memory, magnetic disks, optical disks, and flash memory, as well as any combination or variation thereof, or any other type of storage media. In some implementations, the storage media may be non-transitory. In some instances, at least a portion of the storage media may be transitory. In no case is the storage media a propagated signal.

Processing system 850 is typically mounted on a circuit board that may also hold the storage system. The operating software of storage system 845 comprises computer programs, firmware, or some other form of machine-readable program instructions. The operating software of storage system 845 comprises action application 824. The operating software on storage system 845 may further include an operating system, utilities, drivers, network interfaces, applications, or some other type of software. When read and executed by processing system 850 the operating software on storage system 845 directs computing system 800 to operate as a computing device as described herein. In at least one implementation, the operating software can provide method 200 described in FIG. 2.

In at least one example, action application 824 directs processing system 850 to identify request for a summary of an action caused by an input received from a user and identify the action based on a proximity in time of the action to the request. Action application 824 further directs processing system 850 to generate the summary, the summary including a descriptor for the action, and provide the summary as a response to the request.

In some implementations, the action can be selected based on the most recent action caused by user input before the summary request. In some examples, action application 824 can consider other factors. The factors can include the location of the input in relation to other recent inputs to computing system 800, the user's workflow based on other recent inputs from the user, and the like. For example, action application 824 can identify the workflow of the user, wherein the workflow is the sequence of tasks and actions they perform to accomplish specific goals, such as creating documents, browsing the web, managing emails, or running software applications. An action that deviates from the workflow or is unrelated to the workflow can be selected as the action for the summary.

In some examples, the summary includes a text-based summary, images, videos, or other summary information. The summary can highlight, change color, or otherwise promote any graphical displays that were part of the action (e.g., a menu display). In some examples, the summary includes information about the action performed, the one or more inputs that caused the action, or some other summary associated with the action on the device. In some examples, the summary can provide options for the user to handle the current action and future instances of the action. The options can include permitting the action, undoing the current action, preventing future occurrences of the action, or some other operation associated with the action.

Clause 1. A method comprising: identifying a request for a summary of an action caused by an input received from a user; identifying the action based on a proximity in time of the action to the request; generating the summary, the summary including a descriptor for the action; and providing the summary as a response to the request.

Clause 2. The method of clause 1, wherein the summary further includes a descriptor for the input that caused the action.

Clause 3. The method of clause 1, wherein providing the summary includes: causing display or audio output of the summary.

Clause 4. The method of clause 1 further comprising: providing an option as part of the response that, when selected, is configured to perform an operation to undo the action.

Clause 5. The method of clause 1, wherein the input is a first input, and the method further comprises: providing an option as part of the response that, when selected, is configured to perform an operation to prevent a second input of a same type as the first input from causing the action.

Clause 6. The method of clause 1, wherein the input comprises a first input and wherein the method further comprises: identifying a location of the first input on a display; identifying at least one location of at least one additional input on the display associated with at least one additional action; and determining a distance of the location from the at least one location; wherein identifying the action is further based on the distance.

Clause 7. The method of clause 1, wherein the request comprises a first request, and wherein the method further comprises: identifying a second request for a second summary of a second action caused by a second input received from the user; identifying the second action based on a second proximity in time of the second action to the first request; generating a second summary, the second summary including at least a descriptor for the second action; and providing the second summary as a response to the second request.

Clause 8. The method of clause 1, wherein the action comprises a first action, and wherein the method further comprises: identifying the first action and at least one additional action; determining a workflow associated with the at least one additional action; and determining a relationship of the first action to the workflow; wherein identifying the action is further based on the relationship.

Clause 9. A computer-readable storage medium having program instructions stored thereon that, when executed by at least one processor, direct the at least one processor to perform a method, the method comprising: identifying a request for a summary of an action caused by an input received from a user; identifying the action based on a proximity in time of the action to the request; generating the summary, the summary including a descriptor for the action; and providing the summary as a response to the request.

Clause 10. The computer-readable storage medium of clause 9, wherein the summary further includes a descriptor for the input that caused the action.

Clause 11. The computer-readable storage medium of clause 9, wherein providing the summary includes: causing display or audio output of the summary.

Clause 12. The computer-readable storage medium of clause 9, wherein the method further comprises: providing an option as part of the response that, when selected, is configured to perform an operation to undo the action.

Clause 13. The computer-readable storage medium of clause 9, wherein the input is a first input, and wherein the method further comprises: providing an option as part of the response that, when selected, is configured to perform an operation to prevent a second input of a same type as the first input from causing the action.

Clause 14. The computer-readable storage medium of clause 9, wherein the input comprises a first input and wherein the method further comprises: identifying a location of the first input on a display; identifying at least one location of at least one additional input on the display associated with at least one additional action; and determining a distance of the location from the at least one location; wherein identifying the action is further based on the distance.

Clause 15. The computer-readable storage medium of clause 9, wherein the request comprises a first request, and wherein the method further comprises: identifying a second request for a second summary of a second action caused by a second input received from the user; identifying the second action based on a second proximity in time of the second action to the first request; generating a second summary, the second summary including at least a descriptor for the second action; and providing the second summary as a response to the second request.

Clause 16. The computer-readable storage medium of clause 9, wherein the action comprises a first action, and wherein the method further comprises: identifying the first action and at least one additional action; determining a workflow associated with the at least one additional action; and determining a relationship of the first action to the workflow; wherein identifying the action is further based on the relationship.

Clause 17. A computing apparatus comprising: computer-readable storage media; at least one processor operatively coupled to the computer-readable storage media; and program instructions stored on the computer-readable storage media that, when executed by the at least one processor, direct the computing apparatus to perform a method, the method comprising: identifying a request for a summary of an action caused by an input received from a user; identifying the action based on a proximity in time of the action to the request; generating the summary, the summary including a descriptor for the action; and providing the summary as a response to the request.

Clause 18. The computing apparatus of clause 17, wherein the method further comprises: providing an option as part of the response that, when selected, is configured to perform an operation to undo the action.

Clause 19. The computing apparatus of clause 17, wherein the input is a first input, and the method further comprises: providing an option as part of the response that, when selected, is configured to perform an operation to prevent a second input of a same type as the first input from causing the action.

Clause 20. The computing apparatus of clause 17, wherein the input comprises a first input and wherein the method further comprises: identifying a location of the first input on a display; identifying at least one location of at least one additional input on the display associated with at least one additional action; and determining a distance of the location from the at least one location; wherein identifying the action is further based on the distance.

In this specification and the appended claims, the singular forms “a,” “an” and “the” do not exclude the plural reference unless the context dictates otherwise. Further, conjunctions such as “and,” “or,” and “and/or” are inclusive unless the context dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections, or logical connections may be present in a practical device. Moreover, no item or component is essential to the practice of the implementations disclosed herein unless the element is specifically described as “essential” or “critical.”

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, the use of terms such as up, down, top, bottom, side, end, front, back, etc. herein are used concerning a currently considered or illustrated orientation. If they are considered concerning another orientation, such terms must be correspondingly modified.

Further, in this specification and the appended claims, the singular forms “a,” “an”and “the”do not exclude the plural reference unless the context dictates otherwise. Moreover, conjunctions such as “and,” “or,” and “and/or” are inclusive unless the context dictates otherwise. For example, “A and/or B”includes A alone, B alone, and A with B.

Although certain example methods, apparatuses, and articles of manufacture have been described herein, the scope of coverage of this patent is not limited thereto. It is to be understood that the terminology employed herein is to describe aspects and is not intended to be limiting. On the contrary, this patent covers all methods, apparatus, and articles of manufacture fairly falling within the scope of the claims of this patent.

What is claimed is:

1. A method comprising:
identifying a request for a summary of an action caused by an input received from a user;
identifying the action based on a recency of the action to the request;
generating the summary, the summary including a descriptor for the action; and
providing the summary as a response to the request.

2. The method of claim 1, wherein the summary further includes a second descriptor for the input that caused the action.

3. The method of claim 1, wherein providing the summary includes:
causing display of the summary or an audio output of the summary.

4. The method of claim 1 further comprising:
providing an option as part of the response that, when selected, is configured to perform an operation to undo the action.

5. The method of claim 1, wherein the input is a first input, and the method further comprises:
providing an option as part of the response that, when selected, is configured to perform an operation to prevent a second input from causing the action, the second input being of a same type as the first input.

6. The method of claim 1, wherein the input comprises a first input and wherein the method further comprises:
identifying a first location of the first input on a display;
identifying at least one second location of at least one additional input on the display associated with at least one additional action; and
determining a distance of the first location from the at least one second location;
wherein identifying the action is further based on the distance.

7. The method of claim 1, wherein the request comprises a first request, and wherein the method further comprises:
identifying a second request for a second summary of a second action caused by a second input received from the user;
identifying the second action based on a second proximity in time of the second action to the first request;
generating the second summary, the second summary including at least a second descriptor for the second action; and
providing the second summary as a second response to the second request.

8. The method of claim 1, wherein the action comprises a first action, and wherein the method further comprises:
identifying the first action and at least one additional action;
determining a workflow associated with the at least one additional action; and
determining a relationship of the first action to the workflow;
wherein identifying the action is further based on the relationship.

9. A computer-readable storage medium having program instructions stored thereon that, when executed by at least one processor, direct the at least one processor to perform a method, the method comprising:
identifying a request for a summary of an action caused by an input received from a user;
identifying the action based on a proximity in time of the action to the request;
generating the summary, the summary including a descriptor for the action; and
providing the summary as a response to the request.

10. The computer-readable storage medium of claim 9, wherein the summary further includes a second descriptor for the input that caused the action.

11. The computer-readable storage medium of claim 9, wherein providing the summary includes:
causing display of the summary or an audio output of the summary.

12. The computer-readable storage medium of claim 9, wherein the method further comprises:
providing an option as part of the response that, when selected, is configured to perform an operation to undo the action.

13. The computer-readable storage medium of claim 9, wherein the input is a first input, and wherein the method further comprises:
providing an option as part of the response that, when selected, is configured to perform an operation to prevent a second input from causing the action, the second input being of a same type as the first input.

14. The computer-readable storage medium of claim 9, wherein the input comprises a first input and wherein the method further comprises:
identifying a first location of the first input on a display;
identifying at least one second location of at least one additional input on the display associated with at least one additional action; and
determining a distance of the first location from the at least one second location;
wherein identifying the action is further based on the distance.

15. The computer-readable storage medium of claim 9, wherein the request comprises a first request, and wherein the method further comprises:
identifying a second request for a second summary of a second action caused by a second input received from the user;
identifying the second action based on a second proximity in time of the second action to the first request;
generating the second summary, the second summary including at least a second descriptor for the second action; and
providing the second summary as a second response to the second request.

16. The computer-readable storage medium of claim 9, wherein the action comprises a first action, and wherein the method further comprises:
identifying the first action and at least one additional action;
determining a workflow associated with the at least one additional action; and
determining a relationship of the first action to the workflow;
wherein identifying the action is further based on the relationship.

17. A computing apparatus comprising:
computer-readable storage media;
at least one processor operatively coupled to the computer-readable storage media; and
program instructions stored on the computer-readable storage media that, when executed by the at least one processor, direct the computing apparatus to perform a method, the method comprising:
identifying a request for a summary of an action caused by a set of one or more inputs received from a user;
identifying the action based on a proximity in time of the action to the request;
generating the summary, the summary including a descriptor for the action; and
providing the summary as a response to the request.

18. The computing apparatus of claim 17, wherein the method further comprises:
providing an option as part of the response that, when selected, is configured to perform an operation to undo the action.

19. The computing apparatus of claim 17, wherein the set of one or more inputs comprises a first input, and the method further comprises:
providing an option as part of the response that, when selected, is configured to perform an operation to prevent a second input from causing the action, the second input being of a same type as the first input.

20. The computing apparatus of claim 19, wherein the method further comprises:
identifying a third input;
determining that the third input satisfies at least one similarity criterion to the first input; and
in response to determining that the third input satisfies the at least one similarity criterion, blocking a second action associated with the third input.
